(19) United States
(12) Patent Application Publication
(10) Pub. No.: US 2009/0071214 A1
(43) Pub. Date: Mar. 19, 2009

(54) Steel tube with excellent steam oxidation resistance and method for producing the steel tube

(76) Inventor: Hiroshi Matsuo, London (GB)

Correspondence Address: CLARK & BRODY, 1090 VERMONT AVENUE, NW, SUITE 250, WASHINGTON, DC, 20005, US

(21) Appl. No.: 12/230,496

(22) Filed: Aug. 29, 2008

Related U.S. Application Data
(63) Continuation of application No. PCT/JP2007/053632, filed on Feb. 27, 2007.

(30) Foreign Application Priority Data
Mar. 2, 2006 (JP) 2006-055778

(51) Int. Cl. C21D 7/06; F16L 9/00

(52) U.S. Cl. 72/53; 138/177

(57) ABSTRACT

A steel tube with excellent steam oxidation resistance and a method for producing the steel tube are provided. The steel tube contains 9 to 28% by mass of Cr, and the visual coverage of the shot peened area of the inner surface of the steel tube is 70 percent or more. The method for producing the steel tube includes shot peening the inner surface of the steel tube under the condition of a shot stream of not less than 5 kg/minute and satisfying the formula (a) shown below while rotating the steel tube and moving a shot nozzle along the length of the steel tube. The shot peened area (visual coverage) of the inner surface of the steel tube is 70 percent or more;

L×r/v≧1.5 (a)

where L denotes a length (mm) over which shot particles from the nozzle are blasted onto the inner surface of the tube, r denotes the frequency of rotation (rpm) of the steel tube, and v denotes the speed (mm/minute) of nozzle movement along the length of the steel tube.

The disclosure of International Application No. PCT/JP2007/053632 filed Feb. 27, 2007 including specification, drawings and claims is incorporated herein by reference in its entirety.

### TECHNICAL FIELD

The present invention relates to a steel tube with excellent steam oxidation resistance and a method for producing the steel tube.

### BACKGROUND ART

In a heat exchanger tube made of stainless steel or other alloys, scale is generated due to oxidation by steam on the inner surface of the tube. The scale partially exfoliates due to the thermal shock caused by repetition of the start and stop process. The exfoliated scale sometimes leads to obstruction in which causes overheating in the tube, which may lead to a bursting accident.

Preventing the growth of the scale is effective in solving problems accompanying the exfoliation of the scale. For that purpose, increasing the content of Cr, Si and Al contained in the tube material, refining of grains, and plastic working by shot peening or the like are effectively adapted.

The improvement in steam oxidation resistance by shot peening is proposed, for example, in patent documents 1 and 2. The effect is based on the following principle. When a tube, having an inner surface that has been subjected to plastic working by the use of steel balls or the like, contacts with high-temperature overheated steam, an extremely thin scale of Cr oxides is uniformly generated on the inner surface. This scale has a good protective property and can be stably present for a long time, whereby the steam oxidation resistance is improved.

Patent document 3 proposes a method for preventing oxidation caused by high temperature steam. This method includes peening the surface of austenitic stainless steel by blasting it with particles of carbon steel, alloy steel, or stainless steel at a blast pressure of 4.0 kg/cm² or more and a shot stream of 0.023 kg/cm²/min or more thereby forming a processed layer on the surface.

This plastic working of the inner surface of the tube has been extensively used since it can be carried out at a low cost compared with other methods. However, it is difficult to perfectly prevent the exfoliation of scale, which results from the thermal shock by the repeated stop and start process, even if this method is used, or even if the above-mentioned other measures are taken.

[Patent document 1] Publication of Japanese Patent Application Hei 6-322489

[Patent document 2] Publication of Japanese Patent Application 2002-285236

[Patent document 3] Publication of Japanese Patent Application Shou 52-8930

[Patent document 4] Publication of Japanese Patent Application Hei 6-226633

### DISCLOSURE OF THE INVENTION

### Problems to be Solved by the Invention

An object of the present invention is to provide a steel tube possessing excellent steam oxidation resistance and having formed on its inner surface a uniform shot-peened layer. Another object is to provide a method for producing the steel tube.

### Means to Solve the Problems

While the steam oxidation resistance can be improved by shot peening the inner surface of the tube, to fully exploit the shot peening effect, the shot-peened layer must be substantial and uniform on the inner surface throughout the length and circumference of the tube.

Conventional assessment of shot peening is normally carried out by microscopic observation of a longitudinal cross section of the tube and by measuring the hardness of the inner surface of the tube. Therefore no estimation relating to the length and circumference of the tube is made. This prevents satisfactory and uniform shot peening if there are variations in the amount or type of blast pressure on shot particles along the length or circumference of the tube. In portions where the shot peening is insufficient, abnormally oxidized scale generates in a steam oxidation atmosphere, resulting in poor resistance to steam oxidation.

In view of these circumstances, the present inventor conducted an extensive study of the shot peened area of the tube inner surface using visual coverage as the evaluation index. This study confirmed that shot peening under a condition where visual coverage is 70% or more achieved a steel tube with excellent steam oxidation resistance on the inner surface.

The term abnormally oxidized scale, as used here, refers to the scale that results from damage to the thin, uniform and highly protective scale generated in a high temperature steam oxidation atmosphere. This abnormally oxidized scale has low protectivity and might be stripped away over time, resulting in a tube with low steam oxidation resistance.

The present invention, based on the above knowledge, relates to the following (1) steel tube and (2) a method for producing the steel tube.

(1) A steel tube excellent in steam oxidation resistance, characterized by containing 9 to 28% by mass of Cr, wherein the visual coverage of the shot peened area of the inner surface of the steel tube is 70% or more.

(2) A method for producing a steel tube excellent in steam oxidation resistance, which contains Cr in the range of 9 to 28% by mass, characterized by shot peening the inner surface of the steel tube under the condition of a shot stream of not less than 5 kg/minute and satisfying the formula (a) shown below while rotating the steel tube and moving a shot nozzle along the length of the steel tube, in order that the visual coverage of the shot peened area of the inner surface of the steel tube is 70% or more,

L×r/v≧1.5 (a)

where L denotes a length (mm) over which shot particles from the nozzle are blasted onto the inner surface of the tube, r denotes the frequency of rotation (rpm) of the steel tube, and v denotes the speed (mm/minute) of nozzle movement along the length of the steel tube.

### EFFECTS OF THE INVENTION

The steel tube according to the present invention possesses excellent steam oxidation resistance on its inner surface. The steel tube is suitable for use in, for example, boiler tubes which are subjected to steam oxidation. Moreover, the scale generated on this tube does not easily exfoliate when subjected to thermal stress from repeated heating and cooling, thereby minimizing accidents such as tube obstructions.

### BRIEF DESCRIPTION OF THE DRAWINGS

FIG. 1 is a schematic diagram showing shot peening on the inner surface of the steel tube.

FIG. 2 is a graph showing the relation between visual coverage and the surface area ratio of the abnormally oxidized scale after the steam oxidation test.

### BEST MODE FOR CARRYING OUT THE INVENTION

The present inventor confirmed that steel tube possessing excellent steam oxidation resistance on the inner surface can be obtained by shot peening under the condition that visual coverage is 70% or more. The visual coverage is more preferably 85% or more.

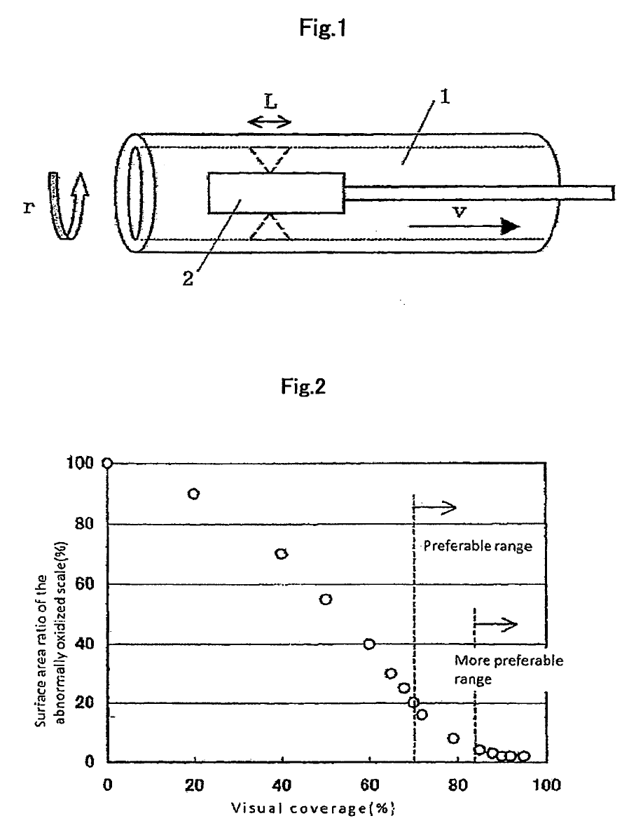

To obtain a high percentage of visual coverage, the shot peening must achieve a uniform shot distribution. This requires satisfying the following conditions. FIG. 1 is a diagram illustrating the processing conditions.

(1) A steel tube 1 is rotated to prevent uneven distribution of shot particles due to gravity and also to prevent a consequent non-uniform coverage along the circumference of the tube. The steel tube 1 may be fixed while rotating a shot nozzle 2.

(2) The shot nozzle 2 is moved along the length of the steel tube 1 at an appropriate speed to ensure that the shot peening uniformly covers the inner surface of the steel tube 1.

(3) The nozzle must be able to blast the shot over a wide range of the inner surface of the tube. In other words, the nozzle should possess a large L shown in FIG. 1 and described later.

(4) An insufficient amount of shot blasted through the nozzle onto the inner surface of the tube makes the shot peening non-uniform so that there is no shot on some portions of the tube. A shot stream of 5 kg/minute or more is required in order to avoid these non-shot portions.

In the method of this invention, the inner surface of the steel tube is shot peened under the condition of a shot stream of not less than 5 kg/minute while rotating the steel tube, and satisfying formula (a) shown below in order to fulfill the conditions above (1), (2), and (3).

L×r/v≧1.5 (a)

More preferably, the value of L×r/v is 2.0 or greater.

L, r, and v are defined as follows.

L denotes the length (mm) over which shot particles through the nozzle are blasted onto the inner surface of the tube.

r denotes the frequency of rotation (rpm) of the steel tube.

v denotes the speed (mm/minute) of the nozzle movement along the length of the steel tube.

Ensuring that the shot particles are blasted uniformly onto the inner surface of the tube can be confirmed, for example, by using the magnetic shot particles disclosed in patent document 4 and monitoring the shot stream by the magneto-resistance method.

The visual coverage of the inner surface of the tube may be measured in the following manner.

A light source is irradiated from one end of a shot peened tube and projected onto its inner surface while a TV camera for observing the inner surface is inserted from the other end and moved within the tube to measure the shot peened area. Note that this measuring method is merely one example, and that another method or combination of other methods may also be utilized.

The value of the visual coverage of the shot peened area is expressed as a percentage relative to the area of the inner surface of the tube. The shot peened surface has a matte finish because of minute depressions and protrusions, whereas a portion without shot peening has a luster finish. The degree of luster can therefore be used to discriminate the shot peened area from non-peened portions.

Tubes within the scope of the present invention typically include tubes used in boilers such as alloy steel tubes, ferritic stainless steel tubes, and austenitic stainless steel tubes. Though there are no strict specifications for the tube material, the tube essentially contains 9 to 28% by mass of Cr, since the scale on the inner surface of the tube must be mainly made of an oxide of Cr.

Examples of the material for the tube of the present invention include an alloy steel of STBA 26, a ferritic stainless steel such as SUS 410, an austenitic stainless steel such as SUS 304H, SUS 309, SUS 310, SUS 316H, SUS 321H and SUS 347H, which are determined in JIS, and corresponding steels thereof.

Shot peening is performed after heat treatment of the steel tube for micro-structural and strength adjustments. Shot peening may be performed either after removing the oxidized scale generated on the inner surface of the tube by heat treatment or performed with the oxidized scale still on the inner surface. On austenitic stainless steel tube, which is usually stored or used after removing the oxidized scale, the shot peening is in most cases performed after removing the oxidized scale. Shot particles for shot peening may be made for example from alumina or steel. If the shot particle material is different from the material of the steel tube, such as when using martensitic steel balls, then particle fragments might remain on the surface of the shot peened steel, causing rust and pitting corrosion. In this case, the particle fragments are preferably removed by pickling after the shot peening, etc.

Chemical compositions of applicable steels are exemplified below. In the following description “%” for component content means “% by mass”.

(1) A ferritic stainless steel containing C: 0.2% or less, Si: 2.0% or less, Mn: 0.1 to 3.0% and Cr: 9 to 28%. This steel may further contain optionally one or more selected from the group consisting of Ni: 0.1 to 1.5%, Mo: 0.1 to 5%, W: 0.1 to 10%, Cu: 0.1 to 5%, N; 0.005 to 0.3%, V: 0.01 to 1.0%, Nb: 0.01 to 1.5%, Ti: 0.01 to 0.5%, Ca: 0.0001 to 0.2%, Mg: 0.0001 to 0.2%, Al: 0.0001 to 0.2%, B: 0.0001 to 0.2% and rare earth elements: 0.0001 to 0.2%.

(2) An austenitic stainless steel containing C: 0.2% or less, Si: 2.0% or less, Mn: 0.1 to 3.0%, Cr: 15 to 28% and Ni: 6 to 50%. This steel may further contain optionally one or more selected from the group consisting of Mo: 0.1 to 5%, W: 0.1 to 10%, Cu: 0.1 to 5%, N: 0.005 to 0.3%, V: 0.01 to 1.0%, Nb: 0.01 to 1.5%, Ti: 0.01 to 0.5%, Ca: 0.0001 to 0.2%, Mg: 0.0001 to 0.2%, Al: 0.0001 to 0.2%, B: 0.0001 to 0.2% and rare earth elements: 0.0001 to 0.2%.

The effect of each component of the above steels and the reason for limiting the content will be described below.

C: Not more than 0.2%

C is an element effective in ensuring tensile strength and creep strength, and it is preferably contained in an amount of 0.01% or more to obtain this effect. However, a content exceeding 0.2% does not contribute to improvement in high-temperature strength but badly affects mechanical properties such as toughness, since carbide that can not solute is left in the steel after solution treatment. Accordingly, the content of C is set to 0.2% or less. The content is desirably 0.12% or less for preventing deterioration of hot workability and toughness.

Si: Not more than 2%

Si is an element used as a deoxidizer and effective in improving the steam oxidation resistance, and it is preferably contained in an amount of 0.1% or more. On the other hand, since an excessive amount of Si causes deterioration of weldability and hot workability, the content is set to 2% or less, desirably, 0.8% or less.

Mn: 0.1 to 3.0%

Mn is effective as a deoxidizer similarly to Si, and has the effect of preventing the deterioration of hot workability resulting from S included as an impurity. For improvement in deoxidizing effect and hot workability, Mn is contained in an amount of 0.1% or more. Since an excessively large content causes embrittlement of the steel, the upper limit of the content is set to 3.0%, more preferably 2.0%.

Cr: 9 to 28%

The steel should include Cr in an amount of 9 to 28% since Cr generates a scale mainly composed of Cr oxides on the inner surface of the tube. Cr is a necessary element for ensuring temperature strength, oxidation resistance and corrosion resistance. In ferritic stainless steel, a content of 9% or more is required for sufficient exhibition of the effect. However, since an excessive content causes deterioration of toughness and hot workability of the steel, the upper limit is set to 28%. In austenitic stainless steel, the Cr content is preferably 15 to 28% due to the above reasons.

Ni: 6 to 50% in austenitic stainless steel; 0.1 to 1.5% in ferritic stainless steel

In austenitic stainless steel, Ni is an element necessary for stabilizing an austenite microstructure and improving the creep strength, and a content of 6% or more is required. Further, in order to ensure stability of the microstructure at elevated temperatures for a long time, a content of 15% or more is preferable. However, since the effect saturates if a large amount of Ni is added, and a content of 50% or more only leads to an increase in cost, the upper limit of the content is set to 50%. A preferable upper limit is 35%, more preferably 25%. In ferritic stainless steel, since Ni is effective in improving the toughness, it can be contained in an amount of 0.1% or more optionally. A content exceeding 1.5% causes deterioration of creep rupture strength.

Mo: 0.1 to 5%, W: 0.1 to 10%, Cu: 0.1 to 5%

Mo, W and Cu are preferably included since they enhance the high-temperature strength of the steel. The effect can be exhibited by including at least one of them in an amount of 0.1% or more. Since too much content impairs the weldability and workability, the upper limit is set to 5% for Mo and Cu, and to 10% for W.

N: 0.005 to 0.3%

N contributes to solid-solution strengthening of the steel. Further, N is fixed with another element and effectively strengthens the steel by a precipitation strengthening effect. In order to obtain the effects, a content of 0.005% or more is required. However, a content exceeding 0.3% may cause deterioration of ductility and weldability of the steel.

V: 0.01 to 1.0%, Nb: 0.01 to 1.5%, Ti: 0.01 to 0.5%

Each of V, Nb and Ti combines with carbon and nitrogen to form carbonitrides and contributes to precipitation strengthening. Accordingly, one or more of them are preferably contained in an amount of 0.01% or more. Since an excessively large content impairs the workability of steel, the upper limit of content is set to 1.0% for V, 1.5% for Nb, and 0.5% for Ti.

Ca: 0.0001 to 0.2%, Mg: 0.0001 to 0.2%, Al: 0.0001 to 0.2%, B: 0.0001 to 0.2%, Rare earth elements: 0.0001 to 0.2%

Each of Ca, Mg, Al, B and rare earth elements, namely La, Ce, Y, Pd, Nd etc. is effective in improving the strength, workability, and steam oxidation resistance. In order to obtain these effects, one or more of them may be contained in an amount of 0.0001% or more, respectively. When each content of these elements exceeds 0.2%, the workability or weldability is impaired.

### EXAMPLE

Stainless steel tubes each with an outer diameter of 50.8 mm and a thickness of 8.0 mm (equivalent to ASME Code 2328-1 with a typical composition of 0.10% C; 0.2% Si, 0.8% Mn; 18.0% Cr; 9.0% Ni; 0.5% Nb; 3% Cu; and 0.1% N) were prepared. Each of the steel tubes was subjected to pickling to remove mill scales off the inner surface of the steel tube, and then shot peened under the conditions described below. Each steel tube was then subjected to pickling to remove remaining shot particles and fragments thereof off the inner surface. A steam oxidation test was carried out on the steel tubes to check for the occurrence of abnormally oxidized scale. Test conditions are described below.

(1) Shot: Martensitic steel balls (with an average diameter of 600 μm)

(2) Shot peening conditions: As listed in Table 1, the frequency (r) of the steel tube rotation, the speed (v) of nozzle movement along the length of the steel tube, a length (L) over which shot particles through the nozzle are blasted onto the inner surface of the tube, the blast pressure, the amount of shot stream, and the amount of blast were all varied to obtain different visual coverage values.

(3) Measurement of the shot peened area (visual coverage) on the inner surface of the tube: A light source was irradiated from one end of the shot peened tube and projected onto its inner surface, while an internal TV camera was inserted from the other end and moved inside the tube to measure the shot peened area. Table 1 also shows the visual coverage values. To verify the measurement, a length of 300 mm was cut off from the tube and cut longitudinally in half to observe the shot peened area on the inner surface of the tube. The value obtained was approximately the same as the value for the area measured with the internal TV camera.

TABLE 1

| | Shot peening conditions | | | | | | | | |
|---|---|---|---|---|---|---|---|---|---|
| | Blast | Amount of | | | | | | | |
| Test | pressure | shot stream | Blast amount | | | | | Visual | |
| Number | (MPa) | (kg/min) | (kg/cm²/min) | r (rpm) | v (mm/min) | L (mm) | L × r/v | coverage (%) | Classification |
| 1 | 0.5 | 4 | 0.20 | 20 | 330 | 5 | 0.3 | 20 | Comparative |
| 2 | 0.5 | 4 | 0.20 | 20 | 250 | 5 | 0.6 | 40 | examples |
| 3 | 0.5 | 4 | 0.40 | 40 | 200 | 5 | 1.0 | 50 | |
| 4 | 0.5 | 5* | 0.63 | 40 | 160 | 5 | 1.3 | 65 | |
| 5 | 0.5 | 4 | 0.62 | 40 | 130 | 5 | 1.5* | 68 | |
| 6 | 0.7 | 7* | 1.17 | 40 | 120 | 5 | 1.7* | 79* | Inventive |
| 7 | 0.7 | 7* | 1.40 | 50 | 100 | 5 | 2.5* | 90* | examples |
| 8 | 0.9 | 15* | 1.50 | 20 | 100 | 10 | 2.0* | 88* | |
| 9 | 0.7 | 15* | 0.75 | 40 | 200 | 10 | 2.0* | 85* | |
| 10 | 0.8 | 7* | 0.09 | 60 | 500 | 15 | 1.8* | 72* | |
| 11 | 0.7 | 10* | 0.33 | 30 | 150 | 20 | 4.0* | 95* | |
| 12 | 0.7 | 7* | 0.12 | 50 | 300 | 20 | 3.3* | 92* | |
| 13 | 0.7 | 5* | 0.06 | 30 | 400 | 20 | 1.5* | 70* | |
| 14 | 0.6 | 5* | 0.25 | 0 | 100 | 20 | 0.0 | 60 | Comparative |
| | | | | | | | | | examples |

Note:
The values with asterisk are within the inventive ranges

Table 1 shows that a visual coverage of 70% or more is obtained when the frequency (r) of rotation of the steel tube, the speed (v) of nozzle movement, and a length (L) over which shot particles through the nozzle are blasted onto the inner surface of the tube are adjusted to satisfy “L×r/v≧1.5” (formula (a)).

(4) Steam oxidation test

Steel tubes were shot peened under varied conditions to yield different visual coverage values. A test piece of 25 long and 20 mm wide was cut off each steel tube and exposed to a steam oxidation atmosphere of 650° C. for 10000 hours to generate a scale. The surface area ratio of the abnormally oxidized scale was measured and the results are shown in FIG. 2.

FIG. 2 shows that when the visual coverage is 70% or more, the area ratio of the abnormally oxidized scale is 20% or less, which indicates that the scale on the inner surface of the tube possesses excellent steam oxidation resistance. FIG. 2 also reveals that when the visual coverage is 85% or more the area ratio of the abnormally oxidized scale was significantly reduced to 5% or less, which indicates that the steam oxidation resistance is further improved.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The steel tube of the present invention provides excellent steam oxidation resistance on its inner surface. This steel tube is effectively applied for example in boiler tubes subjected to steam oxidation. Use of the steel tube prevents accidents resulting from tube obstruction that might otherwise occur due to the generating and exfoliation of the oxidized scale. The steel tube according of the present invention can also be produced at a relatively low cost by the production method of this invention.

### REFERENCE NUMERAL

1. Steel tube
2. Shot nozzle

1. A steel tube excellent in steam oxidation resistance, containing 9 to 28% by mass of Cr,
wherein the visual coverage of a shot peened area of the inner surface of the steel tube is 70% or more.

2. A method for producing a steel tube excellent in steam oxidation resistance, which contains 9 to 28% by mass of Cr, characterized by shot peening the inner surface of the steel tube under the condition of a shot stream of not less than 5 kg/minute and satisfying the formula (a) shown below while rotating the steel tube and moving a shot nozzle along the length of the steel tube, in order that the visual coverage of the shot peened area of the inner surface of the steel tube is 70% or more,
L×r/v≧1.5 (a)
where L denotes a length (mm) over which shot particles from the nozzle are blasted onto the inner surface of the tube, r denotes the frequency of rotation (rpm) of the steel tube, and v denotes the speed (mm/minute) of nozzle movement along the length of the steel tube.
